(19) United States
(12) Patent Application Publication
(10) Pub. No.: US 2019/0053460 A1
(43) Pub. Date: Feb. 21, 2019

(54) Pet toilet

(71) Applicant: Shanghai Bolu Pet Product Co., Ltd., Shanghai (CN)

(72) Inventor: DAWEI YANG, Shanghai (CN)

(21) Appl. No.: 15/943,193

(22) Filed: Apr. 2, 2018

(30) Foreign Application Priority Data
Aug. 17, 2017 (CN) 201710705712.7

(51) Int. Cl. A01K 1/01

(52) U.S. Cl. CPC A01K 1/0107

(57) ABSTRACT

The present invention provides a pet toilet including a shell. The shell includes an upper cover and a sand pot, wherein the sand pot is a semi-oval-shaped shell structure with support legs connected to the sand pot. The lowest bottom of the sand pot has an opening for leaking litters. A garbage bag may be connected the opening. The opening is provided with a baffle. The shape of the upper cover matches the shape of the sand pot. The upper cover and the sand pot are hinged together by a limit connection in back of the pet toilet. And there is an oval inlet in front of the upper cover. The pet toilet of the invention adopts the oval shape, and the overall appearance can fit with the current mainstream household style, and has both practicality and aesthetic appearance. The opening is designed at the lowest point of the semi-oval-shaped sand pot to facilitate the leakage of sand to the garbage bag on their own when the baffle opened, to reduce the manual workload and clean the overall sand pot without staying litter.

### CROSS REFERENCE TO RELATED PATENT APPLICATION

This patent application claims a priority of Chinese patent application 201710705712.7 filed Aug. 17, 2017.

### BACKGROUND OF INVENTION

The present invention relates to a pet product, and more particularly, the present invention directs towards a pet toilet.

Conventional pet toilets, such as cat litter box, are inconvenient for changing litter and cleaning. The cat litter needs to be shovel out for thorough cleaning. The whole litter box is required to be regularly cleaned and disinfected. Although the litter box is for cat use, the cleaning is done by human; thus the design of human engineering is very important. The conventional cat toilet rarely fits the modern home life style. Changing litter and cleaning the litter box are very inconvenient. Younger consumers demand a great deal on the overall home furnishing and design, and thus increase their pet related expenses. Therefore, there is a need for an aesthetic, practical, and safe pet toilet.

### SUMMARY OF THE INVENTION

The present invention provides a pet toilet for more aesthetic, practical, and safe.

In order to achieve the aforementioned functions, there is provided a pet toilet including a shell. The shell includes an upper cover and a sand pot, wherein the sand pot is a semi-oval-shaped shell structure with support legs connected to the sand pot. There is a lower opening at the bottom of the sand pot used for leaking litters. The opening is provided with a baffle. The shape of the upper cover matches the shape of the sand pot. The upper cover and the sand pot are connected together by a hinge or hinges in back of the pet toilet. And there is an oval inlet in front of the upper cover.

The pet toilet of the invention adopts the oval shape, and the overall appearance can fit with the current mainstream household style, and has both practicality and aesthetic appearance. In front of the pet toilet, there is an oval inlet and a sand leakage board for facilitating the cat jump to. There is a handling hole at the outermost area of the sand leakage board to facilitate the lifting of the upper cover. The cat toilet structure is separated by the limit connection in the back of the pet toilet for easy operation. The lower opening is designed at the lowest point of the semi-oval-shaped sand pot to facilitate the leakage of sand on their own to reduce the manual workload, and to clean the overall sand pot without after all the litter is leaked out through the lower opening. The internal structure of the pet toilet is designed for the household use; it provides a good sealed space for pets' sanitary needs, while ensuring the aesthetic appearance and preventing the proliferation of odor.

In one of the embodiments of the pet toilet, the sand leakage board is disposed at the lower edge of the oval inlet, and the sand leakage board is inclined inwardly.

In one of the embodiments of the pet toilet, the handling hole is at the outermost area of the sand leakage board.

In one of the embodiments of the pet toilet, there is a butting plate with a protrusion disposed at the inner side of the upper cover near the lower edge of the oval inlet, and a support part with a concave hole is connected with the sand pot at a position corresponding to the butting plate. When the upper cover is lifted, the butting plate may be supported on the support part, and the protrusion is matched with the concave hole.

In one of the embodiments of the pet toilet, the support legs are integrally connected with the sand pot, the number of the support legs is at least three, and these support legs are disposed in a radiating symmetry distribution.

In one of the embodiments of the pet toilet, the baffle is push-pull covered the opening of the sand pot by a button.

In one of the embodiments of the pet toilet, the baffle is detachably covered the opening of the sand pot by a screw thread.

In one of the embodiments of the pet toilet, the baffle is covered the opening of the sand pot by a hinge.

In one of the embodiments of the pet toilet, the baffle is slidably covered the opening of the sand pot through a chute.

In one of the embodiments of the pet toilet, a garbage bag is detachably connected the opening of the sand pot by a magnetic plate.

Additional aspects and advantages of the invention will be described in the description which follows in part, and be apparent from the description in part, or be realized from the practice of the invention.

### BRIEF DESCRIPTION OF THE DRAWINGS

The present invention will now be specified with reference to its preferred embodiment illustrated in the drawings, in which:

FIG. 1 is a schematic view of the structure of a pet toilet of an embodiment of the present invention.

FIG. 2 is a schematic view of the structure of a pet toilet of an embodiment of the present invention.

FIG. 3 is a schematic view of the structure of a pet toilet of an embodiment of the present invention.

FIG. 4 is a schematic view of the structure of a pet toilet of an embodiment of the present invention.

FIG. 5 is a schematic view of the connection of the baffle of a pet toilet of an embodiment of the present invention.

FIG. 6 is a schematic view of the connection of the baffle of a pet toilet of an embodiment of the present invention.

FIG. 7 is a schematic view of the connection of the baffle of a pet toilet of an embodiment of the present invention.

FIG. 8 is a schematic view of enlarged sectional view of the FIG. 2 illustrating the butting plate along with the support part 6 of a pet toilet of an embodiment of the present invention.

### DESCRIPTION OF THE INVENTION

The embodiments of the invention will be described below with reference to the drawings. The same or similar reference numerals denote the same or similar elements or elements having the same or similar functions. It should be understood that the specific embodiments described herein are merely illustrative of the invention and are not intended to limit the invention.

In the description, it should be understood that the terms “longitudinal”, “horizontal”, “upper”, “lower”, “front”, “rear”, “left”, “right”, “Horizontal”, “top”, “bottom”, “inside”, “outside” and the like are based on the orientation or positional relationship shown in the drawings only for the purpose of describing the invention, it is not instructions or implied means that the device or element must have a specific orientation, constructed and operated in a particular orientation, and therefore it should not be construed as limiting the invention.

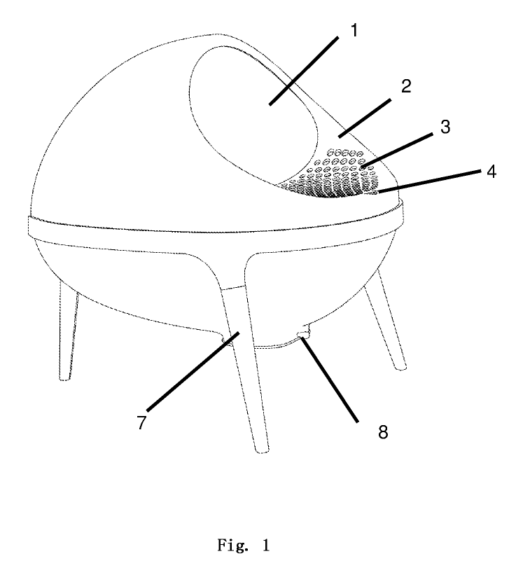

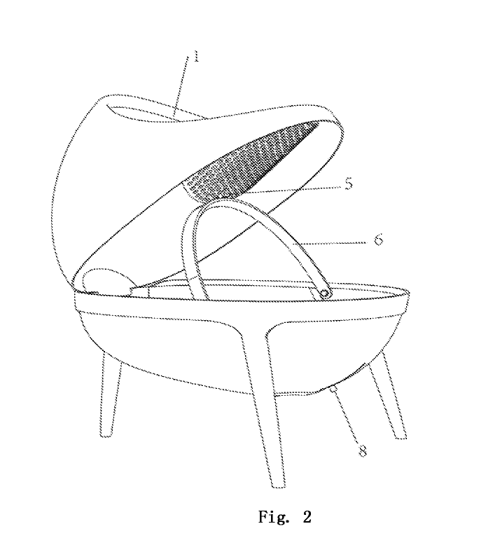

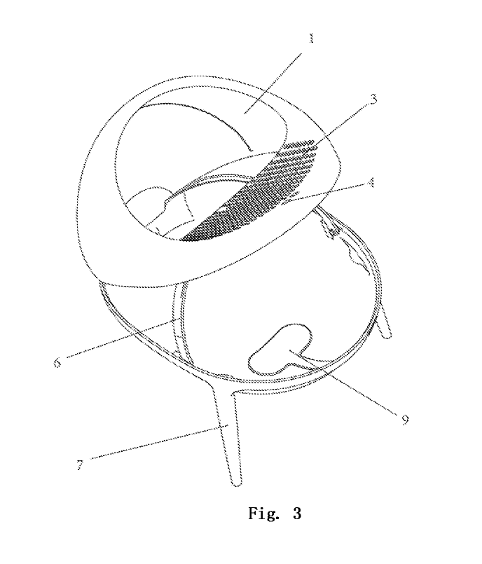

As shown in FIGS. 1, 2, 3, and 4, a pet toilet includes a shell 1. The shell 1 includes an upper cover 2 and a sand pot 13. The sand pot 13 is a semi-oval-shaped shell structure. Support legs 7 are connected to the sand pot 13. There is a lower opening 12 at the lowest bottom of the sand pot 13 for draining litters. A garbage bag 11 may be connected the opening 12. The opening 12 is provided with a baffle 9. The shape of the upper cover 2 matches the shape of the sand pot 13. The upper cover 2 and the sand pot 13 are connected together by a hinge and hinges located in back of the pet toilet.

There is an oval entrance opening 14 in the upper cover 2. A sand leakage board 3 is disposed at the lower edge of the oval entrance 14, and the sand leakage board 3 is inclined or sloped inwardly. A handling hole 4 is at the outermost area of the sand leakage board 3. The garbage bag 11 is detachably connected to the lower opening 12 of the sand pot 13. In one embodiment, the garbage bag is connected to the lower opening 12 by a magnetic plate 10. The magnetic plate 10 provides a convenient means to attach or to detach the garbage bag 11 the lower opening 12.

The present invention provides an oval entrance 14 in front of the pet toilet, a semi-hollow sand pot 13, and a sand leakage board 3 for the cat to jump onto. It makes the pet enter the pet toilet easier. The sand leakage board 3 is inclined inwardly and has small holes. The sand leakage board 3 is for clearing the sand attached on the cat's feet, and the sand is leaked back to the sand pot 13 via the small holes of the sand leakage board to avoid any contamination to the external environment.

There is an ergonomic handling hole 4 at the outermost area of the sand leakage board 3 to facilitate the lifting of the upper cover 2. The cat toilet structure is separated and connected by the limit connection in the back of the pet toilet for easy operation. The lower opening 12 is designed at the lowest point of the semi-oval-shaped sand pot 13 to facilitate draining sand on their own to reduce the manual workload during routine cleaning.

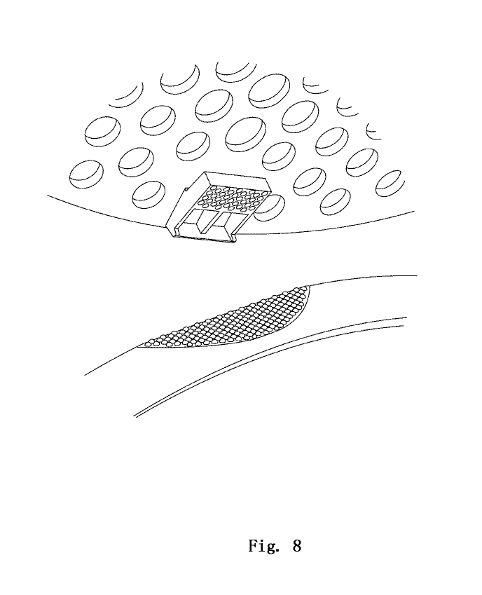

As illustrated in FIG. 8, in one of the embodiments of the invention, there is a butting plate 5 protruding at the bottom of the upper cover 2 near the lower edge of the oval entrance 14, and a support part 6 with a concave hole is connected with the sand pot 13 at a position corresponding to the butting plate 5. When the upper cover 2 is lifted, the butting plate 5 may be supported on the support part 6, and the butting plate 5 is matched with the support part 6's concave hole.

The overall design of the instant pet toilet is a kind of oval-shaped body that can be opened. The interior of the pet toilet is designed with a semicircular support part, and the upper cover can be easily pushed upwards and fastened by the butting plate and the support part to make the scooping of litter more convenient if needed.

In one of the embodiments of the invention, the support legs 7 are integrally connected with the sand pot 13, the number of the support legs 7 is at least three, and these support legs 7 are disposed in a radiating symmetry distribution. A pet toilet with integrated support legs ensures the overall stability. The integrated support legs also provide a certain ground clearance for facilitating attaching the garbage bag to the lower opening 12. Further, the space under the sand pot also allows pets to hide and brings fun for pets.

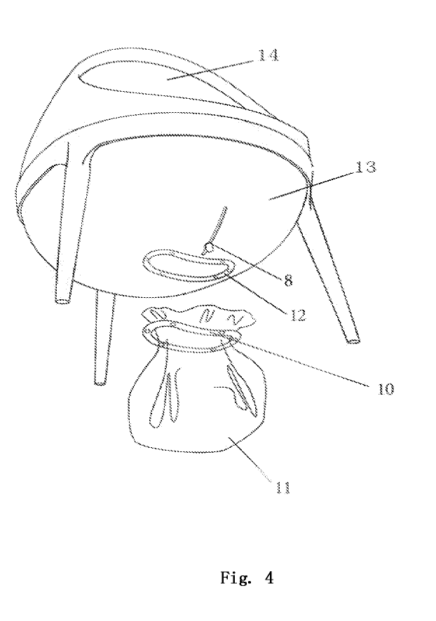

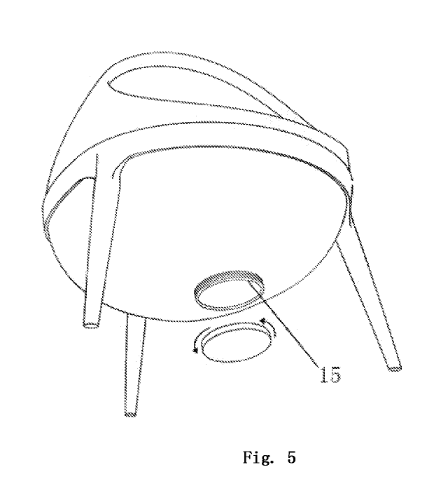

As shown is FIG. 4, in one of the embodiments of the invention, a sliding button 8 controls the baffle 9 to push or to pull the baffle 9 to cover or open the lower opening 12. As shown in FIG. 5, in one of the embodiments of the invention, the baffle 9 is implemented as a screw threaded cover.

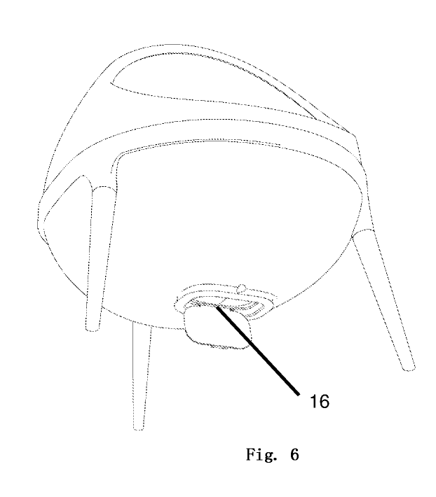

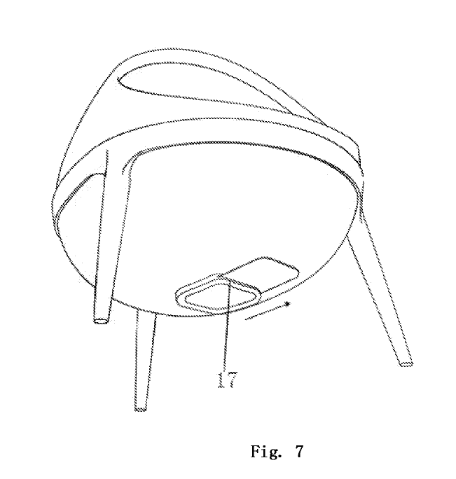

As shown in the FIG. 6, in one of the embodiments of the invention, the baffle 9 is implemented as an external cover hinged on the sand pot 13 by a hinge 16 to cover the lower opening 12. As shown in the FIG. 7, in one of the embodiments of the invention, the baffle 9 is implemented as a sliding external cover sliding along the track 17 for covering or opening the lower opening 12. The invention provides several ways for baffle to cover the opening such as sliding button operated buffle, screw threaded cap, hinged door, sliding door, and the like, which makes the use of the baffle more convenient.

The marks in figures are described as follows: 1 shell, 2 upper cover, 3 sand leakage board, 4 handling hole, 5 butting plate, 6 support part, 7 support legs, 8 button, 9 baffle, 10 plate, 11 garbage bag, 12 opening, 13 sand pot, 14 inlet, 15 screw thread, 16 hinge, 17 chute.

The above description is a preferred embodiment of the invention. And it should be noted that it will be apparent to those skilled in the art that a number of improvements and modifications may be made without departing from the principles of the invention. These improvements and modifications also regarded as the scope of protection of the invention.

What is claimed is:

1. An oval pet toilet, comprising:
a upper cover with an entrance opening;
a sand pot with a lower opening for holding litters, wherein said upper cover is placed above said sand pot, and said upper cover is hinged to said sand pot; and
a baffle for closing or opening said lower opening, wherein said baffle opens said lower opening to drain said litters.

2. The pet toilet of claim 1, further comprising supporting legs connecting to said sand pot.

3. The pet toilet of claim 1, further comprising a sand leakage board disposed at said upper cover and in front of said entrance opening, wherein said sand leakage board is sloped inwardly and comprises a plurality of holes.

4. The pet toilet of claim 3, further comprising a handling hole at an outermost area of the sand leakage board.

5. The pet toilet of claim 3, further comprising three support legs, wherein said support legs are integrally formed with said sand pot, and said support legs are arranged in a radiating symmetric distribution.

6. The pet toilet of claim 1, further comprising a protruding butting plate and a support part with a concave hole, wherein said protruding butting plate is disposed on said upper cover facing said sand box, said support part is connected with said sand pot corresponding to said butting plate, and said protruding butting plate is inserted into said concave hole when said upper cover is in a lifted position.

7. The pet toilet of claim 1, further comprising a sliding button to control said baffle, wherein said baffle is push-pull covered said lower opening by said sliding button.

8. The pet toilet of claim 1, wherein said baffle is a screw threaded cap detachably covered said lower opening by a screw thread.

9. The pet toilet of claim 1, wherein said baffle is a covering plate hinged to said sand pot for covering said lower opening.

10. The pet toilet of claim 1, wherein said baffle is covering plate slidably along a track to cover said lower opening.

11. The pet toilet of claim 1, further comprising a garbage bag attached to said lower opening of said sand pot by a magnetic plate.

12. The pet toilet of claim 11, further comprising a magnetic plate for attaching said garbage to said lower opening.

13. An oval pet toilet, comprising:
a oval upper cover with an entrance opening;
a oval sand pot with a lower opening for holding litters, wherein said oval upper cover is placed above said oval sand pot, and said oval upper cover is hinged to said oval sand pot; and
a baffle for closing or opening said lower opening, wherein said baffle opens said lower opening to drain said litters.
